(19) United States
(12) Patent Application Publication
(10) Pub. No.: US 2005/0191999 A1
(43) Pub. Date: Sep. 1, 2005

(54) Communication terminal, communication system and method in use of same

(75) Inventor: Fumiyoshi Tezuka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/974,773

(22) Filed: Oct. 28, 2004

(30) Foreign Application Priority Data
Feb. 26, 2004 (JP) 2004-52333

(51) Int. Cl. H04M 3/00

(52) U.S. Cl. 455/420; 455/419

(57) ABSTRACT

Since the device priority order table T1 defining the priority order corresponding to the device which a user usually uses is stored in the remote control apparatus 1, the remote control apparatus 1 can be promptly connected to the device with the high priority. Also even in case it is connected to the other device and performs the key input processing to the other device, when the key input is not carried out for a predetermined time, the connection to the device with the higher priority is automatically recovered. Even if a plurality of connections are simultaneously supported, a prompt operation can be performed without a user's recognition of a time lag to the key input processing.

The present application is based on Japanese patent application No. 2004-052333, the entire contents of which are incorporated herein by reference.

### BACKGROUND OF THE INVENTION

1. Field of the Invention

The present invention relates to a communication terminal, a communication system and a communication method that perform by a remote control an operation of a home electric appliance or the like and in particular, to a communication terminal, a communication system and a communication method that can promptly select a home electric appliance desired to be connected by a user without a switching operation of the user.

2. The Related Art of the Invention

With regard to home electric appliances such as a TV or a video recorder, a radio control system has recently become to be popular in general, which directly controls an electric appliance to be controlled by a remote control transmitter.

And accompanying an increasing number of home electric appliances adopting the radio control system there exists a situation where a plurality of remote control transmitters are required each of which operates the respective home electric appliance. For instance, in case a room temperature is adjusted while watching TV, remote control transmitters for the TV and the air conditioner are required to be placed near a user to separately operate them.

On the other hand, a duplex radio communication apparatus has been proposed where in a radio communication device having a single communication device and a plurality of devices connected to the single communication device, a communication state promptly gets back to a predetermined operation state (refer to Japanese Unexamined Patent Publication No. 8-98236).

This duplex radio communication apparatus is constructed of a single main phone and a plurality of cordless handsets.

According to the duplex radio communication apparatus of this Patent Publication, in talking between the single main phone and the plurality of the cordless handsets, after the conversation ends once, the main phone refers to a memory information stored in a memory section with regard to the conversation state by an input of a recovery button and thereby the main phone and the handsets promptly and securely get back to the conversation state before the conversation ends, to recover the conversation, as well as to prevent the handsets from operating as the main phone. And a handset where a conversation ends in the middle of conversation by mistake or a handset for a user who is absent during connecting a line and desires to join the conversation later can join the conversation by receiving the data of the line connection.

This Patent Publication has disclosed the duplex radio communication apparatus that the main phone and all the handsets get back to the conversation state before the conversation ends and recover the conversation. However, this Patent Publication does not disclose a communication system that can promptly communicate with a desired device without any special operation while connected with a plurality of devices. In such communication system, when one device out of the plurality of the devices is communicated, there is a case where the connected device is not necessarily the device to be desired. Then, a switching operation to select the desired device is needed.

### SUMMARY OF THE INVENTION

However, since in the radio communication apparatus with a single main device to a plurality of sub-devices, a sub-device not desired to be connected is likely to be connected to the main device, a labor to switch the connection to a desired sub-device is required and it takes time till the switching to the desired sub-device ends.

Accordingly, an object of the present invention is to provide a communication terminal, a communication system and a method in use of the same, which can promptly connect a device desired to be connected without a user's recognition of device-switching.

A first aspect of the present invention is, in order to achieve the above-described object, to provide a communication terminal which comprises an operation section to operate by a remote control a plurality of operated-side communication terminals, and a communication section to communicate with one operated-side communication terminal selected out of the plurality of the operated-side communication terminals based upon a connection priority order defined for the plurality of the operated-side communication terminals.

A second aspect of the present invention is, in order to achieve the above-described object, to provide a communication terminal which comprises an operation section to operate by a remote control a plurality of operated-side communication terminals, a selection section to select one operated-side communication terminal out of the plurality of the operated-side communication terminals based upon a connection priority order, and a communication section to communicate with the one selected operated-side communication terminal.

A third aspect of the present invention is, in order to achieve the above-described object, to provide a communication system which comprises a plurality of operated-side communication terminals operated by a remote control, and an operating-side communication terminal which selects/operates by a remote control one operated-side communication terminal out of the plurality of the operated-side communication terminals based upon a connection priority order defined for the plurality of the operated-side communication terminals.

A fourth aspect of the present invention is, in order to achieve the above-described object, to provide a communication system which comprises an operating-side communication terminal, a plurality of operated-side communication terminals operated by a remote control by the operating-side communication terminal, and a selection section to select one operated-side communication terminal out of the plurality of the operated-side communication terminals based upon a connection priority order defined for the plurality of the operated-side communication terminals, wherein the operating-side communication terminal operates the selected operated-side communication terminal by the remote control.

A fifth aspect of the present invention is, in order to achieve the above-described object, to provide a communication method which comprises the steps of setting a connection priority order to a plurality of communication terminals to be operated by a remote control, establishing communication with one communication terminal selected based upon the connection priority order, and operating the one selected communication terminal by the remote control which has established the communication.

A sixth aspect of the present invention is, in order to achieve the above-described object, to provide a communication method which comprises the steps of providing an operating-side communication terminal, and providing a plurality of operated-side communication terminals operated by a remote control by the operating-side communication terminal, the method comprising the steps of setting a connection priority order to the plurality of the operated-side communication terminals, selecting one operated-side communication terminal based upon the set connection priority order, establishing communication with the one selected operated-side communication terminal; and
operating the one selected operated-side communication terminal with the established communication by the remote control.

According to the present invention, a device desired to be connected is promptly connected without a user's recognition of device-switching.

These and other objects, features, aspects and advantages of the present invention will be become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is an entire view showing a communication system of a first embodiment according to the present invention;

FIG. 2 is a circuit block view showing major parts of a remote control apparatus and each device;

FIG. 3 is a view showing a device priority order table T1 stored in the remote control apparatus;

FIG. 4 is a view showing a remote control of a device using the remote control apparatus;

FIG. 5 is a view showing an operation of recovery from connection to a device with a second priority order to connection to a device with a first priority order;

FIG. 6 is a view showing an operation ending the device with the second priority order;

FIG. 7 is a flow chart showing a drawing procedure of the device priority order table T1;

FIG. 8 is a flow chart showing an operation of the first embodiment;

FIG. 9 is an entire view showing a communication system of a second embodiment according to the present invention;

FIG. 10 is a circuit block view showing major parts of a cellar phone and each device;

FIG. 11A is a view showing a device priority order table T1 of one device stored in the cellar phone;

FIG. 11B is a view showing a device priority order table T2 of the other device stored in the cellar phone;

FIG. 12A is a view in the case of using the cellar phone as an operation-side communication terminal at a user's home;

FIG. 12B is a view in the case of using the cellar phone as an operation-side communication terminal at a company a user works with;

FIG. 13 is a flow chart showing drawing procedures of device priority order tables T1, T2; and

FIG. 14 is a flow chart showing an operation of the second embodiment.

### DETAILED DESCRIPTION OF THE PREFERRED EMBODIMENTS

Selected embodiments of the present invention will now be explained with reference to the drawings. It will be apparent to those skilled in the art from this disclosure that the following description of the embodiments of the present invention is provided for illustration only, and not for the purpose of limiting the invention as defined by the appended claims and their equivalents.

### First Embodiment

(Entire Construction of System)

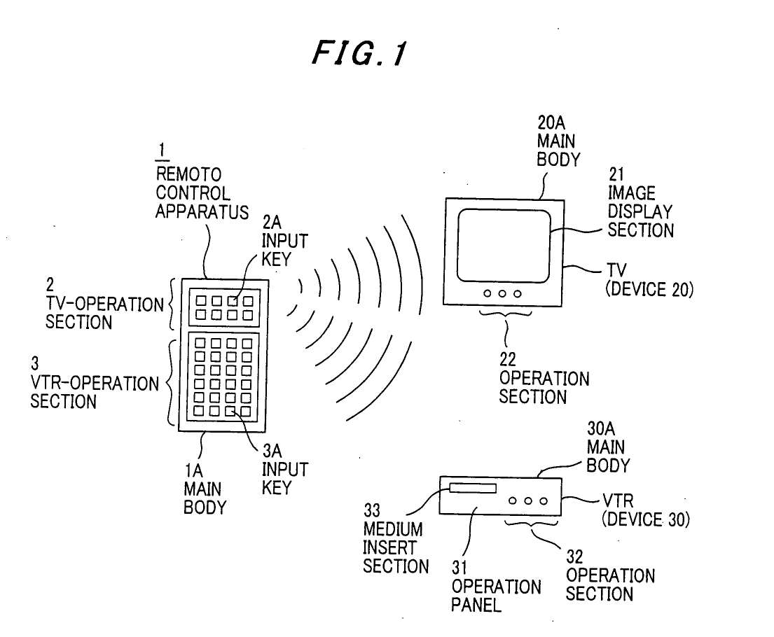

FIG. 1 is an entire view showing a communication system of a first embodiment according to the present invention. A communication system shown in FIG. 1 includes a remote control apparatus 1 as an operating-side communication terminal performing a remote control, a TV (device 20) as an operated-side communication terminal, and a VTR (device 30) as an operated-side communication terminal.

The remote control apparatus 1 includes a main body 1A made of plastic material, and an operation section 3 for the VTR is disposed on a front face of the main body 1A and having a plurality of input keys 3A required to operate the TV. Further, the device 20 is connected to the device 30 by a wire (not shown) so that outputs such as an image, an audio, or the like are possible.

The device (device 20) includes a main body 20A made of plastic material, an image display section 21 formed on a crystal panel and displaying information such as images, characters, or the like, and an operation section 22 disposed on a front face of main body 20A for performing an adjustment of each section.

The VTR (device 30) includes a main body 30A made of metallic material, an operation panel 31 disposed on a front face of the main body 30A, an operation section 32 disposed in the operation panel 31 for performing an adjustment of each section, and a medium insert section 33 disposed in the operation panel 31 for inserting video tapes as a memory medium into the main body 30A.

(Circuit Block View of Remote Control Apparatus 1 and Each Device)

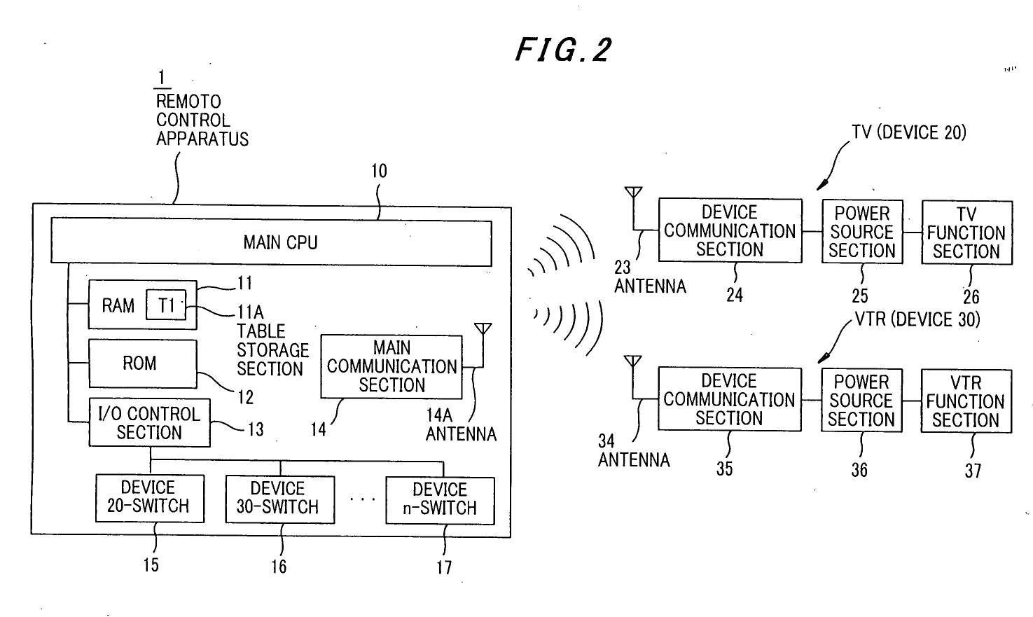

FIG. 2 is a circuit block view showing major parts of the remote control apparatus and each device. The remote control apparatus 1 includes a main CPU 10 performing remote controls of the devices 20, 30, as well as each section of the remote control apparatus 1, a RAM (Random Access Memory) 11 as a memory area used in operating the main CPU 10, a table-storing section 11A disposed in the RAM and storing a device priority order table T1 defining connection priorities of the devices 20, 30, a ROM (READ ONLY MEMORY) 12 storing a procedure of a main CPU operation, various set data, and the like, an I/O control section 13 controlling an input and an output to an operation system of a plurality of devices, device-switches 15-17 inputting remote control signals of the respective devices 20, 30, -n, and a main communication section 14 transmitting/receiving through an antenna 14A a radio wave of a frequency band used in the remote control of the devices 20, 30.

The main CPU 10 controls the main communication section 14 so as to be connected to a device with a high priority with reference to the device priority order table T1 stored in the table-storing section 11A of the RAM 11. And when the communication with the device chosen based the priority is not established, the main CPU transmits an activation signal to the main communication section 14 to activate the device with the second priority defined in the device priority order table T1.

The switches 15-17 for the devices 20-n correspond to a TV-operation section 2 and a VTR-operation section 3 shown in FIG. 1 are constructed of a plurality of switches in response to various functions such as a power source key performing an activation or, a standby of the devices 20-n, a channel operation key, and a sound volume operation key, and perform remote controls for various functions of the devices 20-n. Moreover, the remote control apparatus in FIG. 2 is designed to perform remote controls of other devices in addition to the devices 20, 30.

The main communication section 14 establishes communication with device communication sections 24, 35 by using a radio wave of 2.4 GHz band and transmits a radio wave in response to a key code based upon a key input processing of the remote control apparatus 1.

The TV (device 20) includes the device communication section 24 receiving a remote control signal through the antenna 23, and the power source section 25 performing an activation or a standby of the TV function section 26 of the device 20 based upon the remote control signal. The power source section 25 supplies a power to the TV function section 26 based upon an activation signal inputted from the device communication section 24, to become in an activating state. And the power source section 25 stops the supply of the power based upon a standby signal inputted from the device communication section 24, thereby to make the VTR function section 26 be in a standby state.

The VTR (device 30) includes the device communication section 35 receiving a remote control signal through the antenna 34 and the power source section 36 performing an activation or a standby of the VTR function section 37 of the device 30 based upon the remote control signal. The power source section 36 supplies a power to the VTR function section 37 based upon an activation signal inputted from the device communication section 35, to become in an activating state. And the power source section 36 stops the supply of the power based upon a standby signal inputted from the device communication section 35, thereby to make the VTR function section 37 be in a standby state.

(Construction of Device Priority Order Table T1)

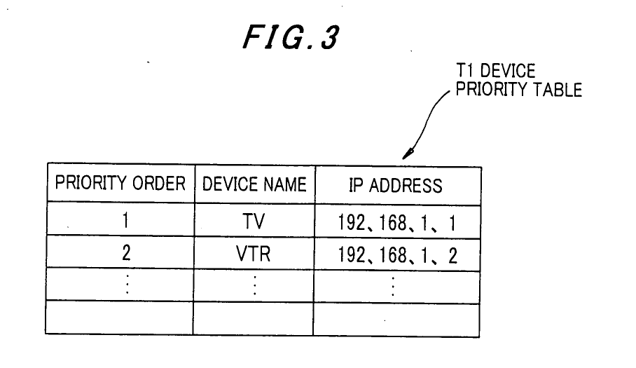

FIG. 3 is a view showing the device priority order table T1 stored in the remote control apparatus. The device priority order table T1 is stored in the table storage section 11A of the RAM 11, and as information with regard to priorities of each device, for instance, priority orders, device names, and IP addresses are stored. In the device priority order table T1, the TV is registered as the first priority device and the VTR as the second priority device. And other devices (not shown) can be registered as priority orders following the second priority order.

(Operation to Activate Device 20 with First Priority Order)

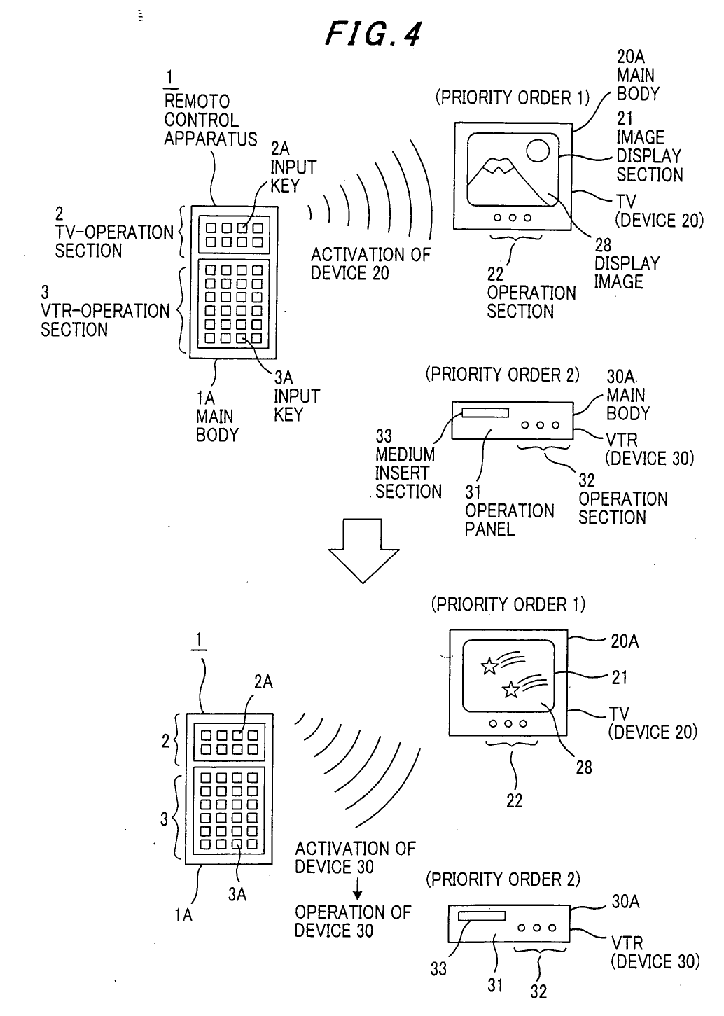

FIG. 4 is a view showing a remote control of a device using the remote control apparatus. In the following explanation, the TV as the device 20 is defined as the first priority and the VTR as the device 30 is defined as the second priority by the above-described device priority order table T1.

When a user operates the power source key disposed in the TV-operation section 2 of the remote control apparatus 1, the remote control apparatus 1 transmits an activation signal as a radio wave to the device 20 defined as the first priority. The device 20 in a standby state is activated by receiving at a device communication section (not shown) a radio wave which the remote control apparatus 1 transmits, and displays on an image display section 21 a display image with regard to a broadcast program.

(Operation in Connecting to the Device 30 with the Second Priority)

Next, in case a user operates the VTR to reproduce the broadcast program recorded, when the user operates the power source key disposed in the VTR-operation section 3 of the remote control apparatus 1, the remote control apparatus 1 disconnects the device 20 to connect the device 30 defined as the second priority and transmits an activation signal as a radio wave to the device 30. The device 30 in a standby state is activated by receiving at a device communication section (not shown) the radio wave the remote control apparatus 1 transmits.

Further, a user operates a reproduction key disposed in the VTR-operation section 3 of the remote control apparatus 1 to the device 30. A display image 28 based upon recorded contents is displayed on the image display section 21 of the device 20 by the reproduction operation.

(Operation to Return the Connection Back to the Device 20 with the First Priority)

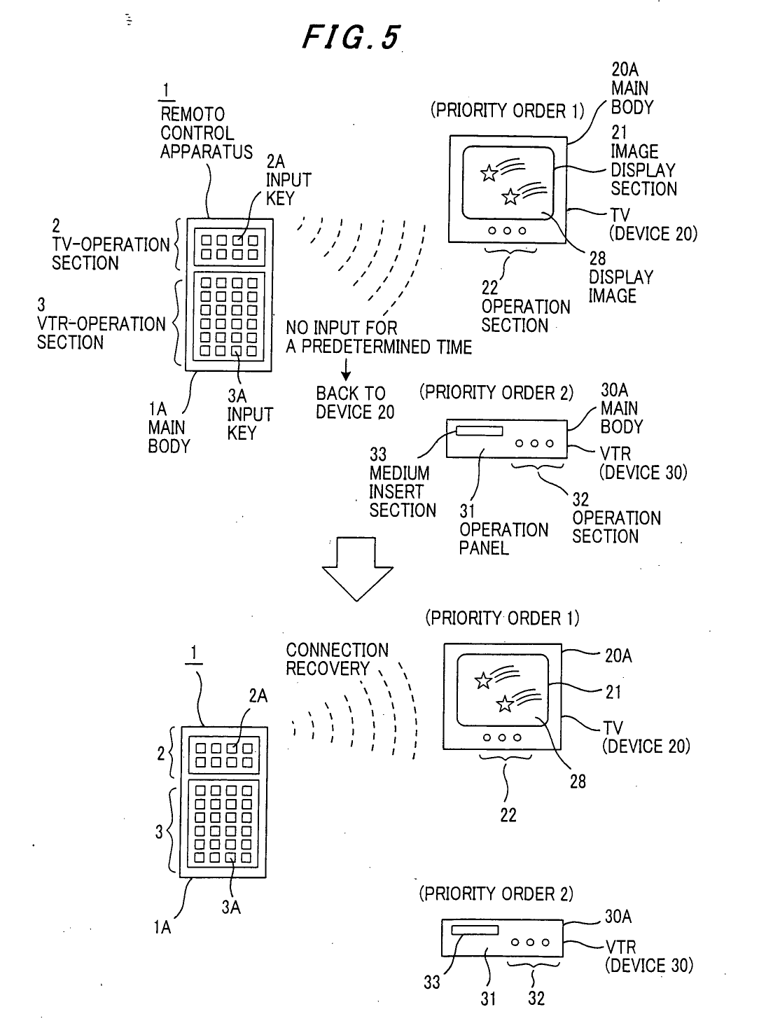

FIG. 5 is a view showing an operation to recover from the connection to the device with the second priority back to the connection to the device with the first priority, after the remote control apparatus 1 performs the reproduction operation of the device 30,

The remote control apparatus 1 disconnects the device 30 and performs switching based upon the priority order defined in the device priority order table T1, to recover to the device 20.

After the recovery, when the a user adjusts a sound volume to the device 20 at the TV-operation section 2 disposed in the remote control apparatus 1, a sound volume adjustment signal is promptly transmitted to the device 20.

(Operation to End the Device with the Second Priority)

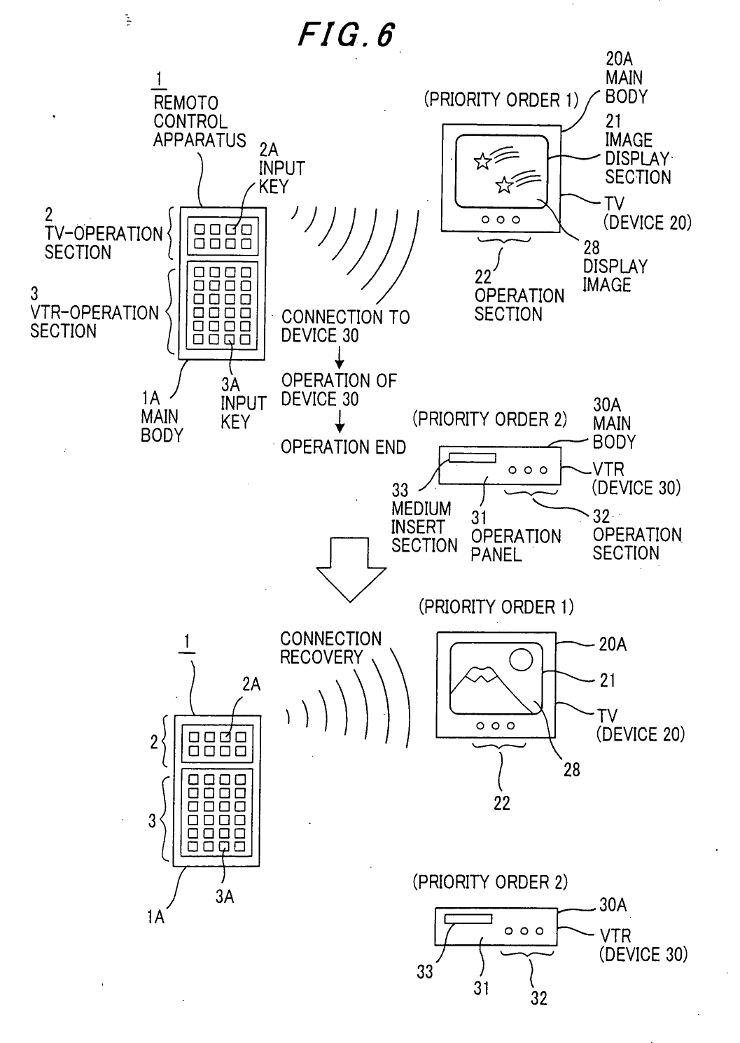

FIG. 6 is a view showing an operation to end the device with the second priority. When a user operates a stopper key disposed in the VTR-operation section 3 in the remote control apparatus 1 to perform ending the reproduction of the recorded contents, a terminator code is inputted to the main CPU in the remote control apparatus 1. This terminator code means that there exists no subsequent processing and the remote control apparatus 1 disconnects the device 30 based upon an input of the terminator code and performs switching based upon the priority order defined in the device priority order table T1, to recover to the device 20.

After the recovery, when the a user adjusts a sound volume to the device 20 at the TV-operation section 2 disposed in the remote control apparatus 1, a sound volume adjustment signal is promptly transmitted to the device 20.

(Production of Device Priority Order Table T1)

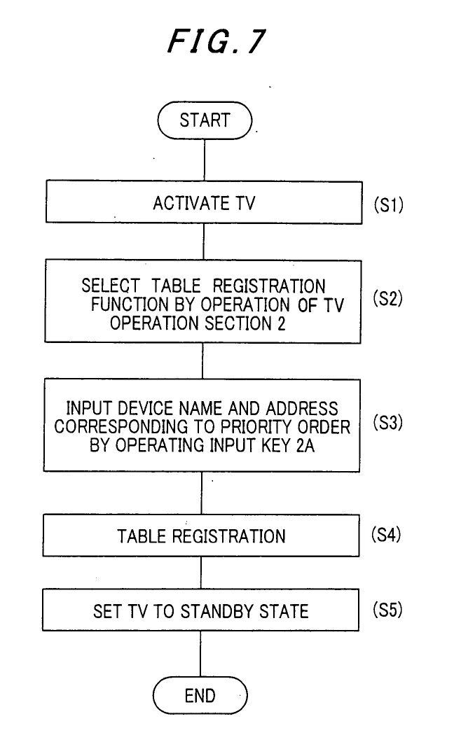

FIG. 7 is a flow chart showing a production procedure of the device priority order table T1. Herein the procedure to produce the device priority order table T1 will be explained by displaying an operation of the remote control apparatus 1 on the TV of the device 20. First, the TV is activated by operating the remote control apparatus 1 (S1). Next, a table registration function is selected by operating the TV operation section 2 of the remote control apparatus 1 (S2). Then, an address name and an address in response to the priority order are inputted by operating the input key 2A to the table displayed on the screen display section 21 of the TV by operating the table selection function (S3). Next, a table registration is made by operating the input key 2A to the table where the input jobs are finished (S4). Then, the TV is set to be in a standby state by operating the remote control apparatus 1 (S5).

(Operation of the First Embodiment)

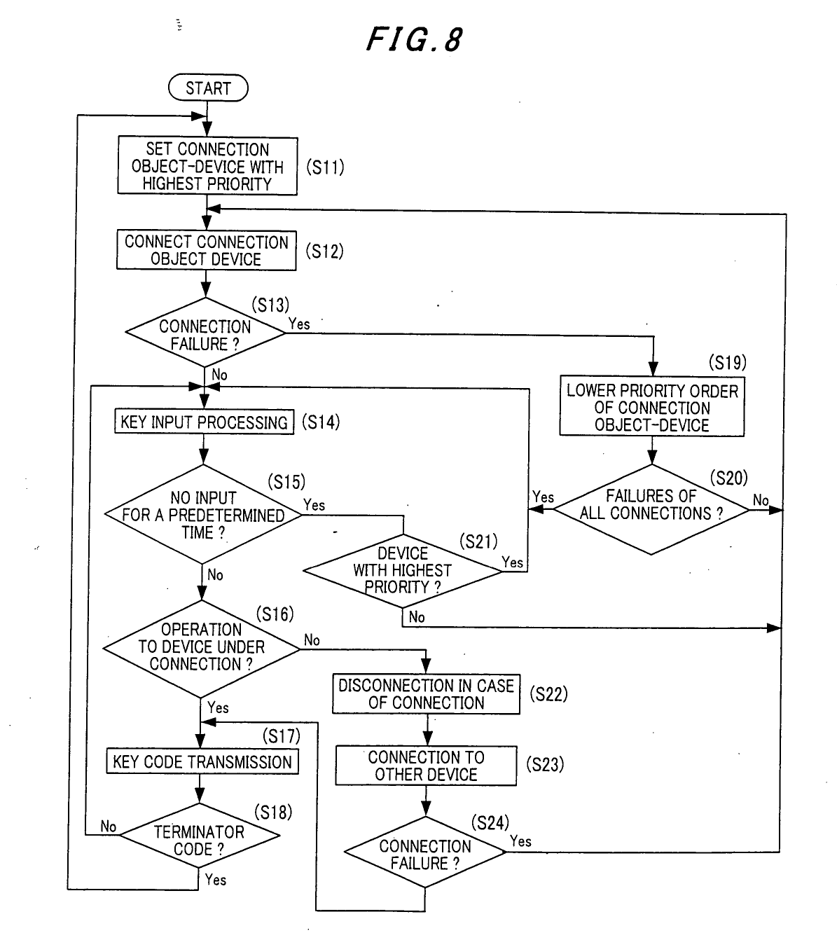

FIG. 8 is a flow chart showing an operation of the first embodiment. An operation thereof will be explained with reference to the drawings in FIG. 1-7 as follows.

In the remote control apparatus 1, the priority orders are in advance set by the device priority order table T1 so that devices a user often uses usually are prioritized (S11). Next, a user operates the remote control apparatus 1 to perform an activation operation to the device usually used often (S12). Herein in the case of operating the remote control apparatus 1 to the device 20, the device 20 is connected based upon operating the TV operation section 2 (S13:NO). The device 20 displays on the image display section 12 the program broadcast at a channel selected. And when the user performs a key input processing such as a channel operation, a sound volume adjustment operation, or the like, the remote control apparatus 1 transmits to the device 20 a key code corresponding to the key input processing by the user (S14).

A user performs key input operations such as a sound volume adjustment and a channel operation to the remote control apparatus 1 during the operating of the device 20 (S15:NO), the remote control apparatus 1 determines that these operations are made to the device 20 under connection (S16:YES), key codes corresponding to the key inputs are transmitted to the device 20 (S17).

When a user ends watching the program and operates the power source key of the TV operation section 2, the terminator code is inputted to the main CPU of the remote control apparatus 1 (S18:YES).

The remote control apparatus 1 transmits the standby signal to the device 20 with the connection still maintained. When the device 20 receives the standby signal, the device 20 becomes in a standby state.

And in case the remote control apparatus 1 can not be connected to the device 20 regardless of the operation of the remote control apparatus 1 (S13:YES), the remote control apparatus 1 lowers the priority order of the device 20 temporarily, as well as selects the device 30 with the second priority so as to be connected thereto (S19). Herein when the remote control apparatus 1 succeeds in the connection to the device 30 (S20: NO), the remote control apparatus 1 waits for a key input operation of a user to the connected device 30 with the second priority.

And in case the connections to all the devices registered in the device priority order table T1 fail due to rejections of the connections or the like (S20:YES), the remote control apparatus 1 waits for a key input operation by a user in a state where the remote control apparatus 1 does not try the connection to any device (S14).

In case the remote control apparatus 1 is being connected to the device 20 as the first priority when no key input operation is performed even after a predetermined time has elapsed (S15: NO), the remote control device 1 waits for a user's key input operation as it is (S21:YES). And when not connected to the device 20 as the first priority, namely when connected to the device 30, the remote control apparatus 1 cuts the connection to the device 30 to switch the connection into the device 20 as the first priority (S21:NO).

When a key input operation to a device other than a device under connection is performed (S16:NO), the remote control apparatus 1 cuts the current connection (S22), to switch the connection into the other device (23). As the remote control apparatus 1 succeeds in being connected into the other device, the remote control apparatus 1 waits for a key input operation from a user (S24:NO). When the connections to the other devices fail, the connection is switched into the device 20 as the first priority (S24:YES).

According to the first embodiment the following effects can be provided.

(1) Since the device priority order table T1 defining the priority order corresponding to the device which a user usually uses is stored in the remote control apparatus 1, the remote control apparatus 1 can be promptly connected to the device with the high priority, as well as even in case it is connected to the other device and performs the key input processing to the other device, when the key input is not carried out for a predetermined time, the connection to the device with the higher priority is automatically recovered. Even if a plurality of connections are simultaneously supported, a prompt operation can be performed without a user's recognition of a time lag to the key input processing.

(2) Since the device priority order table T1 is constructed in response to a user's operation arbitrarily, an operation of altering the priority order with regard to the device with the higher priority can be easily performed.

(3) Since the device to be connected is switched based upon the key input processing to a plurality of devices and after necessary operations end, the connection goes back to the device with higher priority, a troublesome operation or control is not required in switching the connection and an easy and certain connection switching can be performed.

In addition, in the first embodiment it is explained that the device priority order table T1 is produced by defining the priority orders of the devices 20, 30 based upon a user's input operation. However, as a production method of another device priority order table, for instance, how many times a user uses a device is counted and the priority order of the device may be determined by the counted value, and the main CPU 10 may include a learning function of a device use frequency to be mapped on the table.

And in the first embodiment it is explained that two electric devices as the TV and the VTR are operated by a remote control as the operated-side communication terminals, but further, a different operated-side communication terminal can be operated by a remote control by the remote control apparatus 1. Also as a radio system between communication terminals, a radio system based upon a communication standard such as Bluetooth (registered trademark), or a radio LAN can be applied.

### Second Embodiment

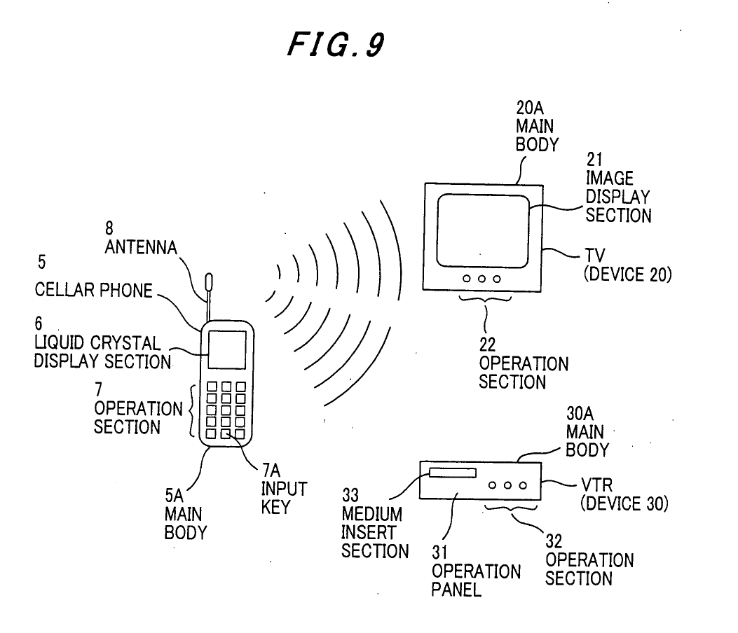

FIG. 9 is an entire view of a communication system of a second embodiment according to the present invention. In the following explanation, components identical to those in the first embodiment are given the identical reference numbers. The second embodiment differs from the first embodiment in that a cellar phone 5 is used as an operating-side communication terminal.

The cellar phone includes a main body 5A formed of resin material, a liquid crystal display section 6 disposed in a front face of the main body 5A, which performs an image display such as a state of the cellar phone 5 and a function-selecting image, and an operation section having an input key 7A which inputs a letter string of numerals, characters, and symbols, as well as performs a function selection, and an antenna 8 which transmits a radio wave for call.

(Cellar Phone 5 and Circuit Block View of Each Device)

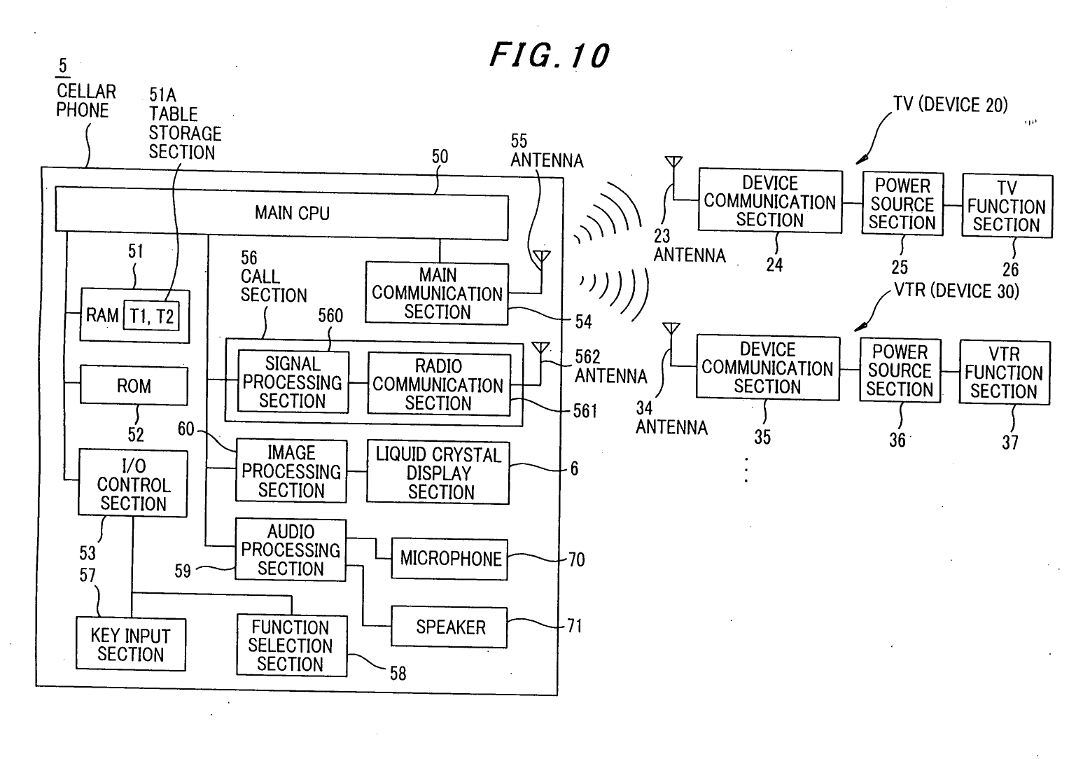

FIG. 10 is a circuit block view showing a major part of a cellar phone and each device. The cellar phone 5 includes a main CPU which performs devices 20, 30 by a remote control and controls each section of the cellar phone 5, a RAM as a memory area used in operating the main CPU 50, a table memory section 51A disposed in the RAM 51, which stores device priority order tables T1, T2 defining priority orders of the devices 20, 30, a ROM 52 which stores procedures of the operation in the main CPU 50 and various fixed data, an I/O control section 53 which controls an input and an output to an operation system of a plurality of the devices, a main communication section 54 which transmits/receives through an antenna 55 a radio wave having a frequency band used for the remote control of the devices 20, 30, a signal processing section 560 which performs a signal processing necessary for a call, a call section having a radio communication section 561 which transmits/receives a radio wave of a frequency band used for the call, an antenna 562 connected to the radio communication section 561, a key input section 57 which operates the cellar phone 5 and the devices 20, 30, a function selection section 58 which calls various functions, an audio processing section 59 which performs an audio processing in the cellar phone 5, an image processing section 60 which performs an image processing such as a display image or the like, a microphone 70 which inputs an audio to the audio processing section 59, and a speaker 71 which outputs the audio from the audio processing section 59.

The main CPU 50 controls the main communication section 54 so that the cellar phone 5 is connected mainly to the device with high priority with reference to the device priority order tables T1, T2. And when the communication with the device selected based upon the priority is not established, the main CPU 50 transmits an activation signal to the main communication section 14 to activate the device with the second priority next to the device with the first priority defined in the device priority order tables T1, T2.

And the main CPU 50 obtains information with regard to communication areas of the cellar phone 5 from the call section 56 communicating with a base station to switch the device priority order tables T1 and T2 stored in the table memory section 51A.

The function selection section 58 is disposed for calling various functions of the cellar phone 5 and has a user to select a function displayed in a hierarchical fashion on the liquid crystal display section 6 based upon an operation of the key input section 57. The remote controls of the devices 20, 30 by the cellar phone 5 are performed by operating the function selection key disposed in the operation section 7 shown in FIG. 9. When a user selects the remote control mode by operating the function selection key, the main CPU 50 reads on the program of the remote control mode from the ROM to perform the mode.

The main communication section 54 establishes communication with device communication sections 24, 35 by using a radio wave of 2.4 GHz band and transmits a radio wave in response to a key code based upon a key input processing of the cellar phone 5.

(Construction of Device Priority Order Tables T1, T2)

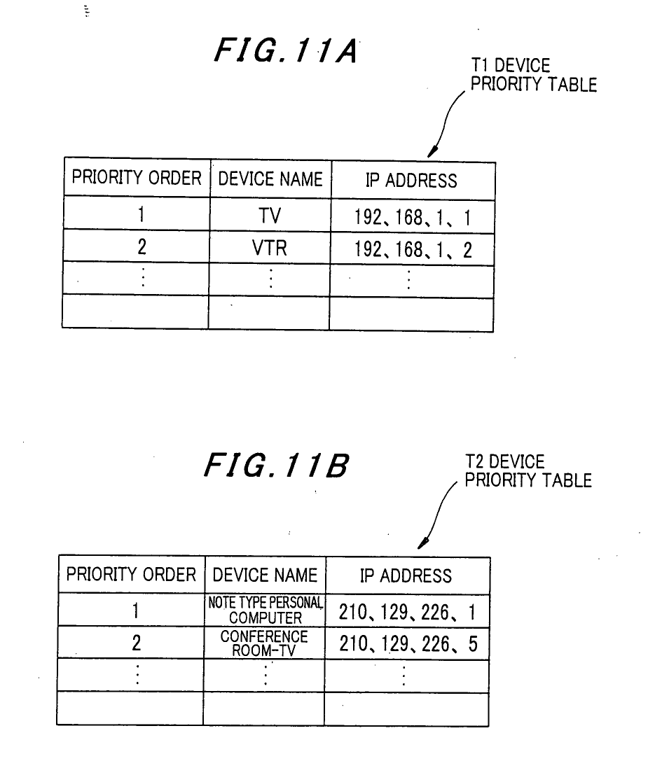

FIGS. 11A and 11B show two device priority order tables stored in the cellar phone. FIG. 11A is a view showing the device priority order table T1 and FIG. 11B is a view showing the device priority order table T2. The device priority order table T1 in FIG. 11A is used when a user uses the cellar phone 5 as the operating-side communication terminal at home and the device priority order table T2 in FIG. 11B is used when a user uses the cellar phone 5 as the operating-side communication terminal at a company which the user works with

The device priority order tables T1, T2 are stored in the table storage section 51A of the RAM 51 and as information with regard to priorities of each device, priority orders, device names, and IP addresses connected to the devices are stored. In the device priority order table T1, the TV is registered as the first priority device and the VTR as the second priority device. In the device priority order table T2, a note personal computer is registered as the first priority device and a conference room-TV as the second priority device.

(Operation of Cellar Phone 5)

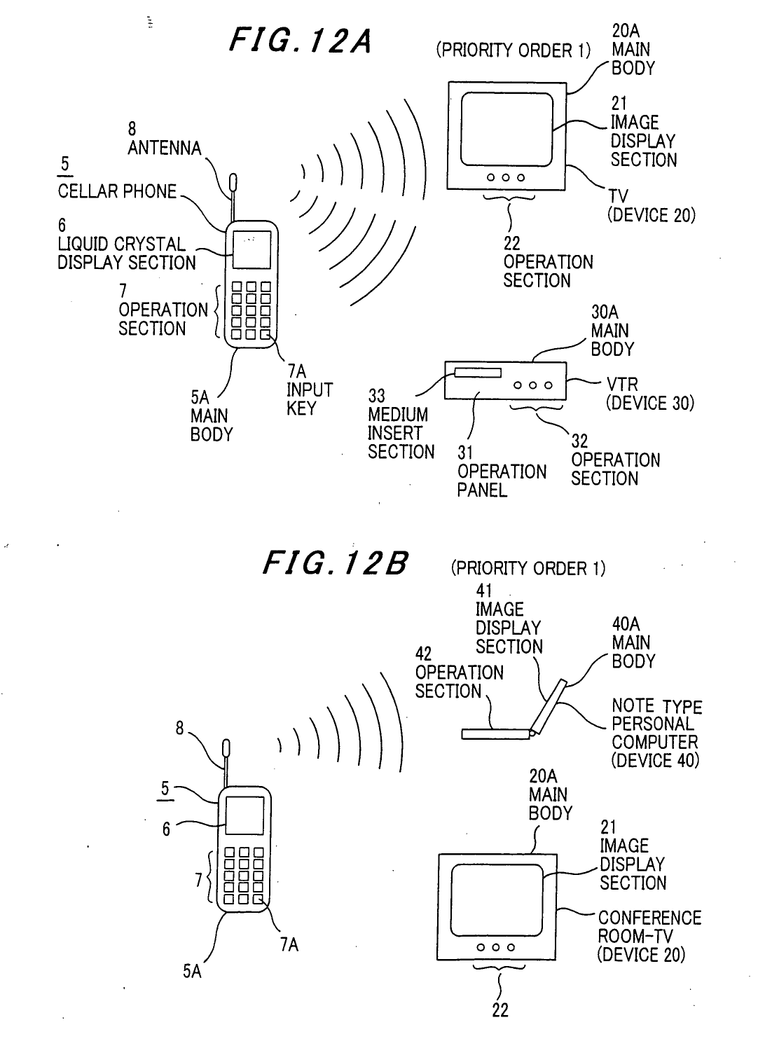

FIGS. 12A and 12B are a view showing remote controls of devices by using a cellar phone. FIG. 12A is a view in use of a cellar phone as an operating-side communication terminal at a user's home and FIG. 12B is a view in use of a cellar phone as an operating-side communication terminal at a company which a user works with. As shown in FIG. 12A, at the user's home, the cellar phone 5 selects the device priority order table T1 based upon information of the communication area obtained by the cellar phone 5, the connection to the TV (device 20) is prioritized so as to mainly operate the TV by a remote control. And when the connection to the device 20 fails and the key input processing to the VTR (device 30) is performed from the cellar phone 5, the priority order of the device 20 is lowered temporarily, as well as the connection processing is performed by selecting the device 30 as the next priority.

And as shown in FIG. 12B, at the company the user works with, the cellar phone 5 selects the device priority order table T2 based upon information of the communication area obtained by the cellar phone 5, the connection to the note type personal computer (device 40) is prioritized so as to mainly operate the note type personal computer by a remote control. And when the connection to the device 40 fails and the key input processing to the conference room-TV (device 20) is performed from the cellar phone 5, the priority order of the device 40 is lowered temporarily, as well as the connection processing is performed by selecting the device 30 as the next priority.

(Production of Device Priority Order Tables T1, T2)

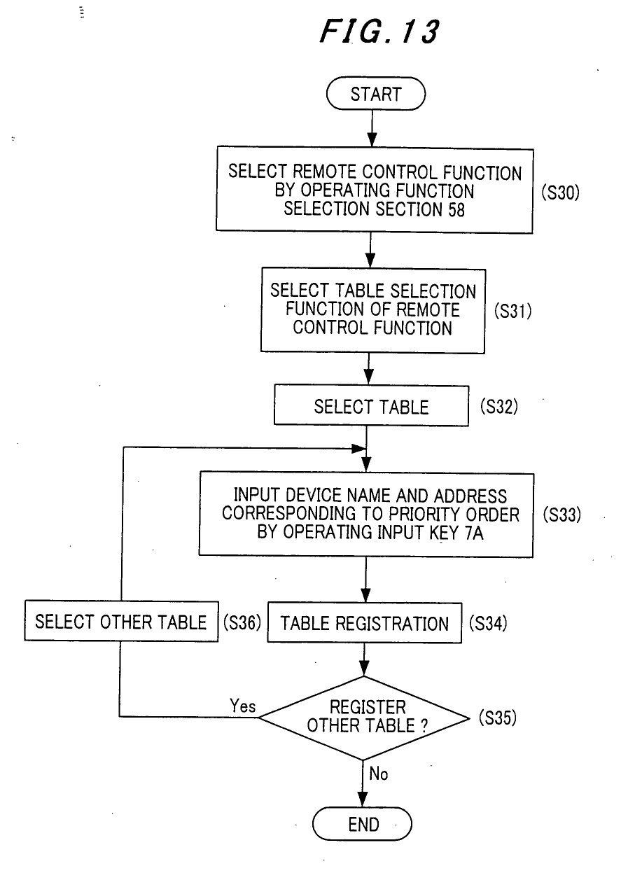

FIG. 13 is a flow chart showing a production procedure of the device priority order tables T1, T2. First, a remote control function is selected by operating the function selection key disposed in the operation section 7 of the cellar phone 5 (30). Next, a table selection function included in the remote control functions is selected by operating the input key 7A of the operation section 7 (31). Next, a table displayed on the image display section 21 of the cellar phone 5 is selected by the table selection function (32), and the device names and the addresses corresponding to the priority order are inputted by operating the input key 7A of the operation section 7 (33). Next, a table which inputs predetermined items is registered as the device priority order table T1 (S34). Next, when registering the other table (S35:YES), a table displayed on the image display section 21 of the cellar phone 5 is selected by the table selection function (S36), and the table is produced by inputting predetermined items (S33). The table thus produced is registered as the device priority order table T2 (S34). And when the other table is not produced (S35:NO), the production of a table ends.

(Operation of the Second Embodiment)

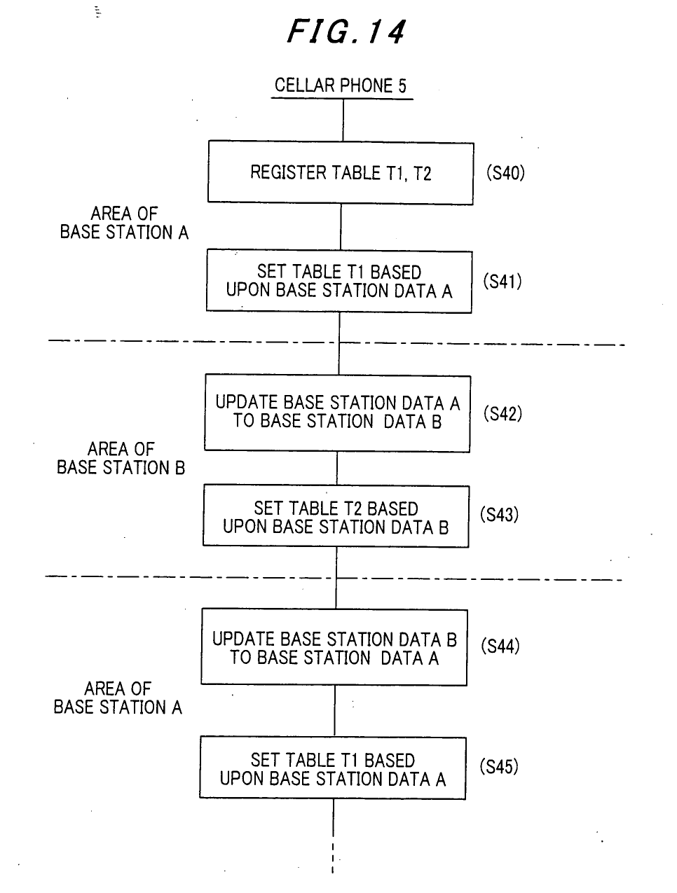

FIG. 14 is a flow chart showing an operation of the second embodiment. In the following explanation, the user produces the device priority order tables T1, T2 explained beforehand in FIG. 11 and stores the device priority order tables T1, T2 in the table storage section 51A of the RAM 51 (S40). Herein the user carrying the cellar phone 5 is in the area of the base station A, and the main CPU 50 of the cellar phone 5 sets the device priority order table T1 stored in the table storage section 51A based upon the information obtained from the base station A (S41).

For instance, when the user's home is in the area of the base station A, the device priority order table T1 is set to the cellar phone 5 and when the user operates the device by selecting the remote control function of the cellar phone 5, the connection is made to prioritize the device 20.

Next, as the user with the cellar phone 5 moves from the area of the base station A to the area of the base station B, the information of the communication area obtained at the cellar phone 5 is updated (S42). The main CPU 50 sets the device priority order table T2 stored in the table storage section 51A based upon the information obtained from the base station B (S43).

For instance, when the company which the user works with is in the area of the base station B, the device priority order table T2 is set to the cellar phone 5 and when the user operates the device by selecting the remote control function of the cellar phone 5, the connection is made to prioritize the device 40.

Next, as the user with the cellar phone 5 moves from the area of the base station B to the area of the base station A, the information of the communication area obtained at the cellar phone 5 is updated (S44). The main CPU 50 sets the device priority order table T1 stored in the table storage section 51A based upon the information obtained from the base station A (S45).

(Effects of the Second Embodiment)

The following effects are provided according to the second embodiment.

(1) Since device priority order tables defining priority orders corresponding to devices which a user usually uses are stored in the cellar phone 5, the devices 20, 30 as the operated-side communication terminals can be operated without use of an exclusive remote control apparatus. And the connection to the device which a user frequently uses is automatically recovered, as well as even when a plurality of connections are not supported, a prompt operation is performed without a user's recognition of the time lag to the key input processing.

(2) since the device priority order tables T1, T2 are selected based upon the information of the communication area obtained by the cellar phone 5, the priority orders of the devices as the operated-side communication terminals can be automatically changed without a user's recognition and the cellar phone 5 can be used as a remote control apparatus even at a location other than a user's home.

However, in the second embodiment, the construction where the cellar phone is used in place of the remote control apparatus is explained and an electric device having a communication function such as a personal computer, a personal digital assistant, or the like can be used.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

1. A communication terminal, comprising:
an operation section to operate by a remote control a plurality of operated-side communication terminals; and
a communication section to communicate with one operated-side communication terminal selected out of the plurality of the operated-side communication terminals based upon a connection priority order defined for the plurality of the operated-side communication terminals.

2. The communication terminal as defined in claim 1, further comprising:
a memory section to store a table which defines the connection priority order.

3. The communication terminal as defined in claim 1, wherein
the operation section includes a plurality of operation sections disposed for the plurality of the operated-side communication terminals.

4. The communication terminal as defined in claim 1, wherein
the operation section uses an input section disposed in a cellar phone.

5. The communication terminal as defined in claim 1, wherein
when the communication section does not communicate with the one operated-side communication terminal selected based upon the connection priority order, the communication section performs communication with an operated-side communication terminal having a second connection priority order as compared to the connection priority order of the one operated-side communication terminal.

6. A communication terminal, comprising:
an operation section to operate by a remote control a plurality of operated-side communication terminals;
a selection section to select one operated-side communication terminal out of the plurality of the operated-side communication terminals based upon a connection priority order; and
a communication section to communicate with the one selected operated-side communication terminal.

7. A communication system, comprising:
a plurality of operated-side communication terminals operated by a remote control; and
an operating-side communication terminal which selects/operates by a remote control one operated-side communication terminal out of the plurality of the operated-side communication terminals based upon a connection priority order defined for the plurality of the operated-side communication terminals.

8. The communication system as defined in claim 7, wherein
the operating-side communication terminal is a remote control apparatus including a table defining the connection priority order with regard to the plurality of the operated-side communication terminals.

9. The communication system as defined in claim 7, wherein
the operating-side communication terminal is a cellar phone including a table defining the connection priority order with regard to the plurality of the operated-side communication terminals.

10. The communication system as defined in claim 7, wherein
the operating-side communication terminal includes a table defining the connection priority order based upon a connection frequency for the plurality of the operated-side communication terminals.

11. A communication system, comprising:
an operating-side communication terminal;
a plurality of operated-side communication terminals operated by a remote control by the operating-side communication terminal; and
a selection section to select one operated-side communication terminal out of the plurality of the operated-side communication terminals based upon a connection priority order defined for the plurality of the operated-side communication terminals, wherein
the operating-side communication terminal operates the selected operated-side communication terminal by the remote control.

12. A communication method, comprising the steps of:
setting a connection priority order to a plurality of communication terminals to be operated by a remote control;
establishing communication with one communication terminal selected based upon the connection priority order; and
operating the one selected communication terminal with the established communication by the remote control.

13. A communication method, comprising the steps of:
providing an operating-side communication terminal; and
providing a plurality of operated-side communication terminals operated by a remote control by the operating-side communication terminal, the method comprising the steps of:
setting a connection priority order to the plurality of the operated-side communication terminals;
selecting one operated-side communication terminal based upon the set connection priority order;
establishing communication with the one selected operated-side communication terminal; and
operating the one selected operated-side communication terminal with the established communication by the remote control.

14. The communication method as defined in claim 13, wherein
the connection priority order of each operated-side communication terminal is defined based upon a connection frequency to each operated-side communication terminal.
